(19) United States
(12) Patent Application Publication
(10) Pub. No.: US 2025/0006034 A1
(43) Pub. Date: Jan. 2, 2025

(54) Sock Tracking Device

(71) Applicant: Jeff Michelson, Gillette, NJ (US)

(72) Inventor: Jeff Michelson, Gillette, NJ (US)

(21) Appl. No.: 18/214,909

(22) Filed: Jun. 27, 2023

(51) Int. Cl. G08B 21/24; A41B 11/00; A41D 1/00; H04W 4/029

(52) U.S. Cl. CPC G08B 21/24; A41B 11/00; A41D 1/002; H04W 4/029

(57) ABSTRACT

A sock tracking device includes a sock and a tracking unit integrated into the sock. The tracking unit is in remote communication with a global positioning system and an extrinsic communication network. A personal electronic device is included which stores a tracking application and the personal electronic device is in remote communication with the tracking unit. The personal electronic device displays the physical location of the sock to the user thereby facilitating the user to locate the sock. Additionally, the personal electronic device broadcasts an alert signal to the tracking unit thereby actuating the tracking unit to emit an audible alert. In this way the user can locate the sock by sound.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to tracking devices and more particularly pertains to a new tracking device for locating a lost sock. The device includes a sock, a tracking unit integrated into the sock and a personal electronic device in wireless communication with the tracking unit. The personal electronic device displays the physical location of the tracking unit and the tracking unit emits an audible alert when a tracking application stored in the personal electronic device is actuated.

### (2) Description of Related Art Including Information Disclosed Under 37 CFR 1.97 and 1.98

The prior art relates to tracking devices including a variety of radio frequency identification (RFID) devices that are integrated into articles of clothing for tracking the articles of clothing and an electronic tracking unit integrated into the sole of a shoe. In no instance does the prior art disclose a tracking unit integrated into a sock to facilitate the sock to be located with a personal electronic device when the sock is lost.

### BRIEF SUMMARY OF THE INVENTION

An embodiment of the disclosure meets the needs presented above by generally comprising a sock and a tracking unit integrated into the sock. The tracking unit is in remote communication with a global positioning system and an extrinsic communication network. A personal electronic device is included which stores a tracking application and the personal electronic device is in remote communication with the tracking unit. The personal electronic device displays the physical location of the sock to the user thereby facilitating the user to locate the sock. Additionally, the personal electronic device broadcasts an alert signal to the tracking unit thereby actuating the tracking unit to emit an audible alert. In this way the user can locate the sock by sound.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sock tracking device according to an embodiment of the disclosure.

FIG. 2 is a cross sectional view taken along line 2-2 of FIG. 1 of an embodiment of the disclosure.

FIG. 3 is a perspective in-use view of an embodiment of the disclosure.

FIG. 4 is a schematic view of an embodiment of the disclosure.

### DETAILED DESCRIPTION OF THE INVENTION

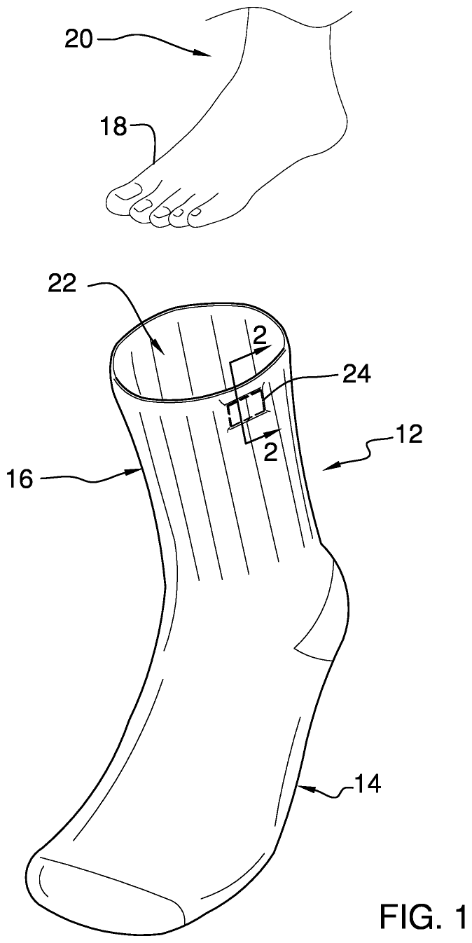

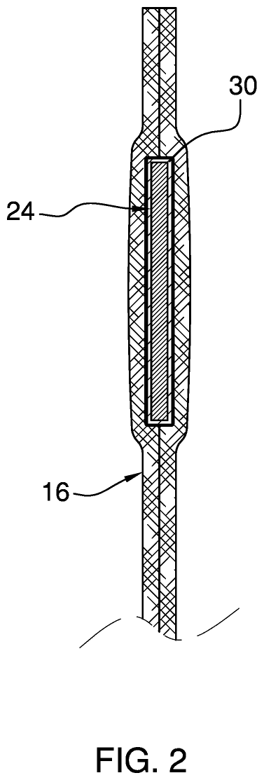

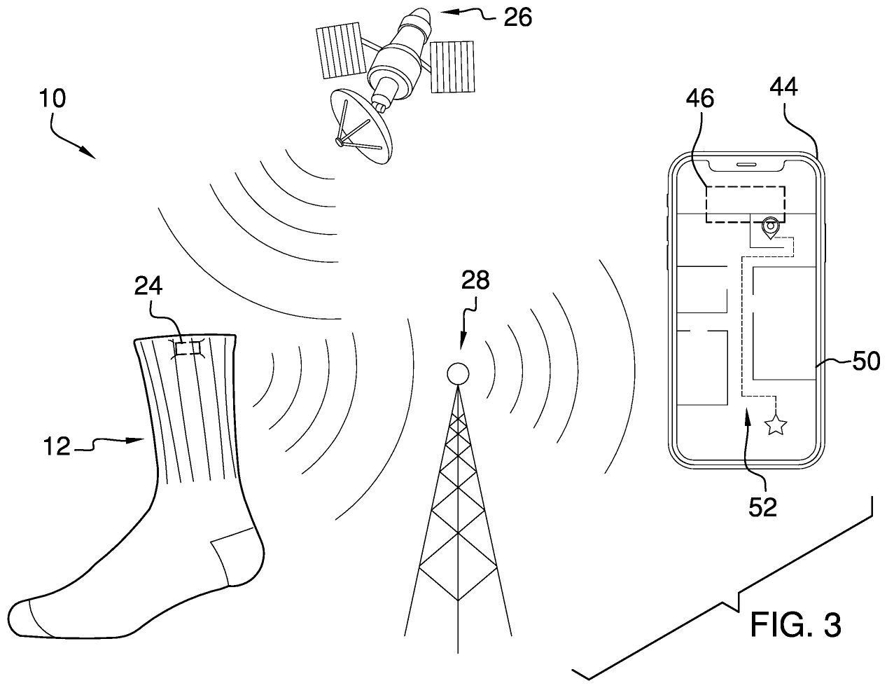

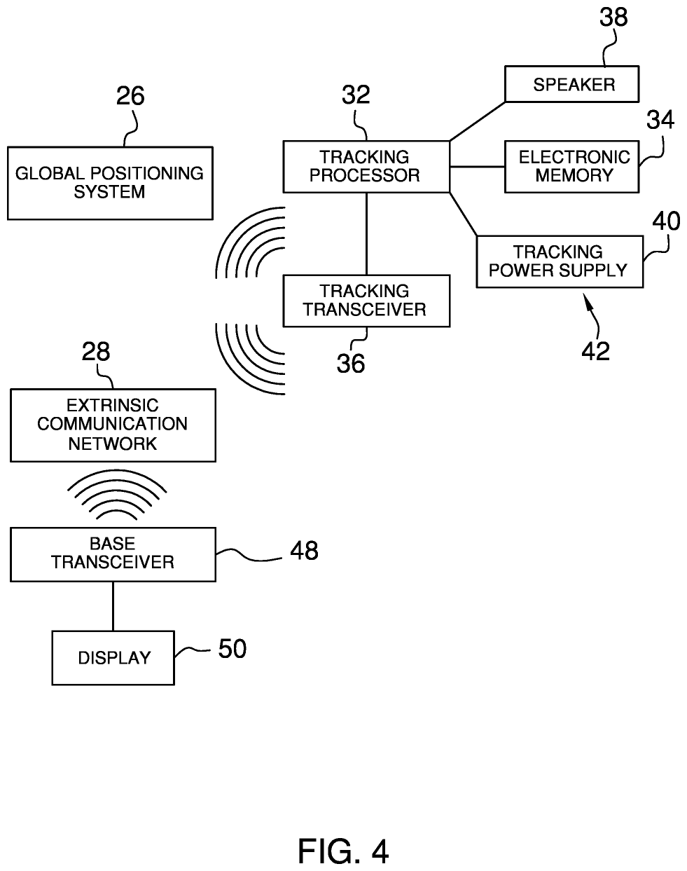

With reference now to the drawings, and in particular to FIGS. 1 through 4 thereof, a new tracking device embodying the principles and concepts of an embodiment of the disclosure and generally designated by the reference numeral 10 will be described.

As best illustrated in FIGS. 1 through 4, the sock tracking device 10 generally comprises a sock 12 that has a foot portion 14 and a leg portion 16 such that the sock 12 can be worn on a foot 18 of a user 20. The leg portion 16 has an opening 22 extending into the sock 12 for receiving the user's foot 18. Furthermore, the sock 12 may be a quarter sock, a mid-calf sock, an over-the-calf sock or any other type of sock commonly worn on people's feet. A tracking unit 24 is provided and the tracking unit 24 is integrated into the sock 12. The tracking unit 24 is in remote communication with a global positioning system 26 to receive the physical location of the sock 12 from the global positioning system 26. Additionally, the tracking unit 24 continually broadcasts a tracking signal which comprises the physical location of the sock 12 to an extrinsic communication network 28. The tracking unit 24 may be an integral part of the sock 12 that is installed during the manufacturing process of the sock 12.

The tracking unit 24 comprises a housing 30 that is integrated into the leg portion 16 of the sock 12 at a point located adjacent to the opening 22 in the leg portion 16. The housing 30 is comprised of a fluid impermeable material to inhibit water from entering the housing 30. The tracking unit 24 includes a tracking processor 32 that is integrated into the housing 30. The tracking processor 32 includes an electronic memory 34 which stores an identification code assigned to the tracking processor 32 and the tracking processor 32 receives an alert input.

The tracking unit 24 includes a tracking transceiver 36 that is integrated into the housing 30 and the tracking transceiver 36 is electrically coupled to the tracking processor 32. Additionally, the tracking transceiver 36 is in wireless communication with the global positioning system 26. The tracking transceiver 36 continually broadcasts the tracking signal to the extrinsic communication network 28. The extrinsic communication network 28 may comprise a cellular phone network, the internet or any other type of wireless communication network. Furthermore, the tracking transceiver 36 may comprise a radio frequency transceiver or the like and the tracking transceiver 36 may be a dual channel transceiver to facilitate the tracking transceiver 36 to simultaneously communicate with the global positioning system 26 and the extrinsic communication network 28.

The tracking unit 24 includes a speaker 38 that is integrated into the tracking housing 30 to emit an audible alert from the tracking housing 30. The speaker 38 is electrically coupled to the tracking processor 32 and the speaker 38 is turned on when the tracking processor 32 receives the alert input. The speaker 38 may comprise a piezoelectric speaker or other type of miniaturized electronic speaker that can emit sound levels with an intensity of at least 70.0 decibels. The tracking unit 24 includes a tracking power supply 40 integrated into the housing 30. The tracking power supply 40 is electrically coupled to the tracking processor 32 and the tracking power supply 40 comprises at least one battery 42.

A personal electronic device 44 is included which stores a tracking application 46 which can be manipulated by the user 20. The personal electronic device 44 is in remote communication with the tracking unit 24 to display the physical location of the sock 12 to the user 20 thereby facilitating the user 20 to locate the sock 12. Furthermore, the personal electronic device 44 broadcasts an alert signal to the tracking unit 24 when a location feature of the tracking application 46 is actuated thereby actuating the tracking unit 24 to emit an audible alert. In this way the tracking unit 24 facilitates the user 20 to locate the sock 12 by sound. The personal electronic device 44 may comprise a smart phone or other type of electronic device that has wireless communication capabilities and data storage capabilities. Additionally, the tracking application 46 may comprise a smart phone application or other type of control program.

The personal electronic device 44 includes a base transceiver 48 that is in wireless communication with the extrinsic communication network 28 thereby facilitating the base transceiver 48 to receiver the tracking signal from the tracking transceiver 36 and the identification code assigned to the tracking processor 32. The personal electronic device 44 includes a display 50 which displays indicia 52 comprising imagery related to the tracking application 46 which shows the physical location of the personal electronic device 44 and the physical location of the tracking unit 24. In this way the display 50 facilitates the user 20 to visually identify the location of the tracking unit 24. The base transceiver 48 may comprise a radio frequency transceiver or the like and the display 50 may comprise a touch screen display commonly employed on smart devices.

In use, the tracking application 46 on the personal electronic device 44 is actuated when the user 20 needs to locate the sock 12. The display 50 displays the physical location of the sock 12 and the speaker 38 emits the audible alert. In this way the sock 12 can be easily located when the sock 12 has become misplaced. Furthermore, the unique identification code stored in the electronic memory 34 facilitates a specific tracking unit 24 in a specific sock 12 to be actuated when the user 20 owns a large number of socks 12. In this way only the speaker 38 in the tracking unit 24 of a sock 12 that has been misplaced is actuated to emit the audible alert and only the physical location of the tracking unit 24 of the sock 12 that has been misplaced is displayed on the display 50.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A sock tracking device for facilitating a user to track the location of socks thereby inhibiting the socks from becoming lost, said device comprising:
a sock having a foot portion and a leg portion wherein said sock is configured to be worn on a user's foot, said leg portion having an opening extending into said sock;
a tracking unit being integrated into said sock such that said tracking unit is enveloped within said sock, said tracking unit being in remote communication with a global positioning system wherein said tracking unit is configured to receive the physical location of said sock from the global positioning system, said tracking unit continually broadcasting a tracking signal which comprises the physical location of said sock to an extrinsic communication network; and
a personal electronic device storing a tracking application wherein said tracking application is configured to be manipulated by the user, said personal electronic device being in remote communication with said tracking unit wherein said personal electronic device is configured to display the physical location of said sock to the user thereby facilitating the user to locate said sock, said personal electronic device broadcasting an alert signal to said tracking unit when a location feature of said tracking application is actuated thereby actuating said tracking unit to emit an audible alert wherein said tracking unit is configured to facilitate the user to locate said sock by sound.

2. The device according to claim 1, wherein said tracking unit comprises a housing being integrated into said leg portion of said sock at a point located adjacent to said opening in said leg portion, said housing being comprised of a fluid impermeable material wherein said housing is configured to inhibit water from entering said housing.

3. The device according to claim 2, wherein said tracking unit comprises:
a tracking processor being integrated into said housing, said tracking processor including an electronic memory storing an identification code assigned to said tracking processor, said tracking processor receiving an alert input; and
a tracking transceiver being integrated into said housing, said tracking transceiver being electrically coupled to said tracking processor, said tracking transceiver being in wireless communication with said global positioning system, said tracking transceiver continually broadcasting said tracking signal to said extrinsic communication network.

4. The device according to claim 3, wherein:
said tracking unit includes a speaker being integrated into said tracking housing wherein said speaker is configured to emit an audible alert from said tracking housing, said speaker being electrically coupled to said tracking processor, said speaker being turned on when said tracking processor receives said alert input; and
a tracking power supply being integrated into said housing, said tracking power supply being electrically coupled to said tracking processor, said tracking power supply comprising at least one battery.

5. The device according to claim 3, wherein said personal electronic device includes a base transceiver being in wireless communication with said extrinsic communication network thereby facilitating said base transceiver to receive said tracking signal from said tracking transceiver and said identification code assigned to said tracking processor.

6. The device according to claim 1, wherein said personal electronic device includes a display which displays indicia comprising imagery related to said tracking application which shows the physical location of said personal electronic device and the physical location of said tracking unit wherein said display is configured to facilitate the user to visually identify the location of said tracking unit.

7. A sock tracking device for facilitating a user to track the location of socks thereby inhibiting the socks from becoming lost, said device comprising:
a sock having a foot portion and a leg portion wherein said sock is configured to be worn on a user's foot, said leg portion having an opening extending into said sock;
a tracking unit being integrated into said sock such that said tracking unit is enveloped within said sock, said tracking unit being in remote communication with a global positioning system wherein said tracking unit is configured to receive the physical location of said sock from the global positioning system, said tracking unit continually broadcasting a tracking signal which comprises the physical location of said sock to an extrinsic communication network, said tracking unit comprising:
a housing being integrated into said leg portion of said sock at a point located adjacent to said opening in said leg portion, said housing being comprised of a fluid impermeable material wherein said housing is configured to inhibit water from entering said housing;
a tracking processor being integrated into said housing, said tracking processor including an electronic memory storing an identification code assigned to said tracking processor, said tracking processor receiving an alert input;
a tracking transceiver being integrated into said housing, said tracking transceiver being electrically coupled to said tracking processor, said tracking transceiver being in wireless communication with said global positioning system, said tracking transceiver continually broadcasting said tracking signal to said extrinsic communication network;
a speaker being integrated into said tracking housing wherein said speaker is configured to emit an audible alert from said tracking housing, said speaker being electrically coupled to said tracking processor, said speaker being turned on when said tracking processor receives said alert input;
a tracking power supply being integrated into said housing, said tracking power supply being electrically coupled to said tracking processor, said tracking power supply comprising at least one battery; and
a personal electronic device storing a tracking application wherein said tracking application is configured to be manipulated by the user, said personal electronic device being in remote communication with said tracking unit wherein said personal electronic device is configured to display the physical location of said sock to the user thereby facilitating the user to locate said sock, said personal electronic device broadcasting an alert signal to said tracking unit when a location feature of said tracking application is actuated thereby actuating said tracking unit to emit an audible alert wherein said tracking unit is configured to facilitate the user to locate said sock by sound, said personal electronic device including a base transceiver being in wireless communication with said extrinsic communication network thereby facilitating said base transceiver to receive said tracking signal from said tracking transceiver and said identification code assigned to said tracking processor, said personal electronic device including a display which displays indicia comprising imagery related to said tracking application which shows the physical location of said personal electronic device and the physical location of said tracking unit wherein said display is configured to facilitate the user to visually identify the location of said tracking unit.

8. (canceled)
